(19) United States
(12) Patent Application Publication
(10) Pub. No.: US 2019/0006869 A1
(43) Pub. Date: Jan. 3, 2019

(54) LIGHT EMITTING DEVICE AND DRIVING METHOD THEREOF

(71) Applicant: Chicony Power Technology Co., Ltd., New Taipei City (TW)

(72) Inventors: Huan-Hsiang HUANG, New Taipei City (TW); Chen-Chi LIN, New Taipei City (TW)

(21) Appl. No.: 15/696,164

(22) Filed: Sep. 5, 2017

(30) Foreign Application Priority Data
Jun. 28, 2017 (CN) 201710509872.4

(51) Int. Cl. H02J 7/00; H05B 33/08

(52) U.S. Cl. CPC H02J 7/0068; H05B 33/083; H05B 33/0812

(57) ABSTRACT

A light emitting device includes several light emitting diode units connected in series with each other and a battery. The battery is coupled to a part of the light emitting diode units. When the light emitting diode units receive power supplied from an external power supply, the external power supply charges the battery through the part of the light emitting diode units, and drives the light emitting diode units, and when the light emitting diode units do not receive power supplied from the external power supply, the battery discharges to drive at least one of the light emitting diode units.

### CROSS-REFERENCE TO RELATED APPLICATION

This application claims the priority benefit of Chinese Application serial no. 201710509872.4, filed Jun. 28, 2017, the full disclosure of which is incorporated herein by reference.

### FIELD OF INVENTION

The invention relates to a light emitting device and a driving method thereof. More particularly, the invention relates to a light emitting device and a driving method thereof for emergency lighting.

### BACKGROUND

The main function of emergency lighting is to provide emergency lighting for users in the event of emergency such as electricity interruption in order to reduce the occurrence of accidents. Usually, during general lighting the mains electricity power provides power to the light emitting device, and during emergency lighting the battery provides power to the light emitting device.

Now the lighting device often replaces the conventional light bulbs with light emitting diodes. However, for the conventional general lighting to have the function of emergency lighting, in addition to the light emitting diodes and circuits of the original general lighting, another group of battery charging circuits and another group of light emitting diodes for emergency lighting are also in need for the event of emergency lighting, and may cause the volume of the lamp to be too large. In order not to make the volume of the lamp too large, it is expected that the light emitting diodes for general lighting to be used as a light emitting diodes for emergency lighting in an emergency situation.

Therefore, how to make the light emitting diodes of the original lighting device to work as an emergency lighting during the emergency situation, are problems to be improved in the field.

### SUMMARY

An embodiment of this disclosure is to provide a light emitting device. The light emitting device includes several light emitting diode units connected in series with each other and a battery. The battery is coupled to a part of the light emitting diode units. When the light emitting diode units receive power supplied from an external power supply, the external power supply charges the battery through the part of the light emitting diode units, and drives the light emitting diode units, and when the light emitting diode units do not receive the power supplied from the external power supply, the battery discharges to drive at least one of the light emitting diode units.

An embodiment of this disclosure is to provide a driving method of a light emitting device. The light emitting device comprises a plurality of light emitting diode units connected in series with each other and a battery, and the battery is coupled to a part of the light emitting diode units. The driving method includes the following operations: detecting whether the light emitting diode units receive power supplied from an external power supply or not; and charging the battery through the part of the light emitting diode units by the external power supply when the light emitting diode units receive power supplied from the external power supply and driving the light emitting diode units, and discharging the battery to drive at least one of the light emitting diode units when the light emitting diode units do not receive the power supplied from the external power supply.

The embodiment of the present disclosure is to provide a light emitting device and a driving method thereof. The light emitting diode units for the conventional general lighting is used as the light emitting diode units for emergency lighting in an emergency situation, thereby effectively reducing the volume of the light emitting device. In addition, the embodiment of the present disclosure utilizes the circuit path of the light emitting diode units of the conventional general lighting to charge the battery, no additional switching power supply is needed, effectively reducing the complexity of the circuits of the light emitting device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a light emitting device according to some embodiments of the present disclosure.

FIG. 2 is a flow diagram illustrating a driving method of a light emitting device according to some embodiments of the present disclosure.

FIG. 3 is a flow chart illustrating one operation in the method of FIG. 2 according to some embodiments of the present disclosure.

FIG. 4 is a flow chart illustrating one operation in the method of FIG. 2 according to some embodiments of the present disclosure.

FIG. 5 is a schematic diagram illustrating a light emitting device according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

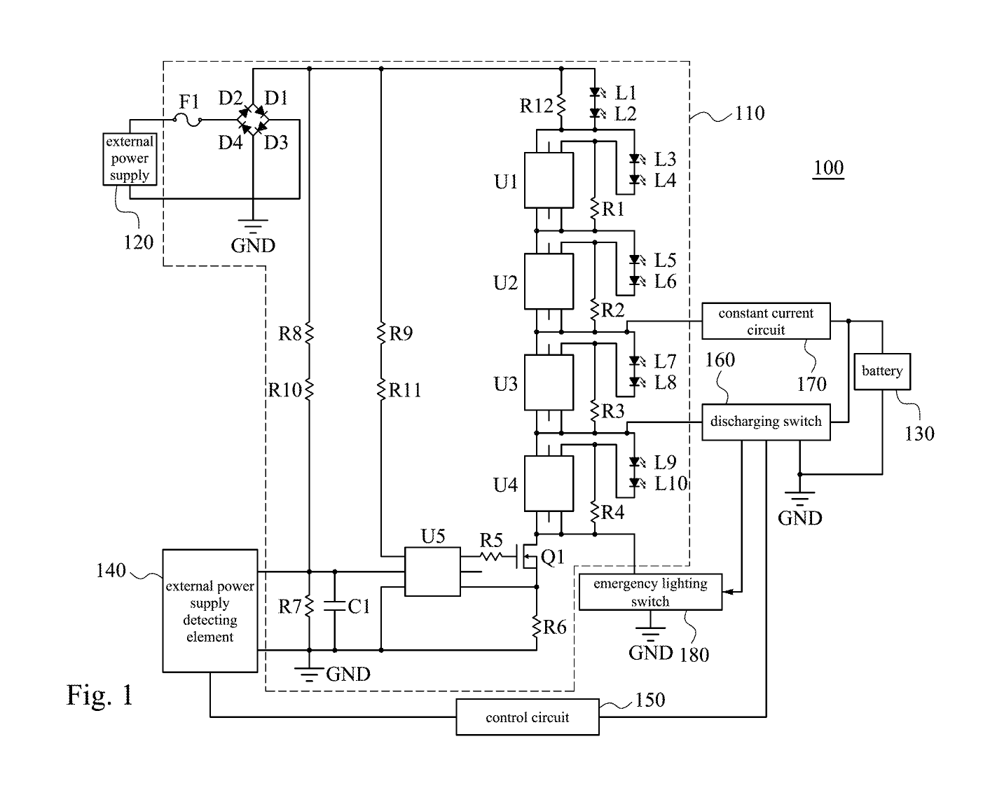

Reference is made to FIG. 1. FIG. 1 is a schematic diagram illustrating a light emitting device 100 according to some embodiments of the present disclosure. The light emitting device 100 includes a light emitting diode power supply 110 for general lighting. As shown in FIG. 1, the light emitting diode power supply 110 for general lighting includes several light emitting diode units L1 to L10. The light emitting diode units L1 to L10 are connected in series with each other.

As shown in FIG. 1, the light emitting diode power supply 110 for general lighting further includes chips U1 to U5, resistors R1 to R12, transistors Q1, diodes D1 to D4, fuse F1, capacitors C1, and ground point GND. The light emitting diode power supply 110 for general lighting shown in FIG. 1 is an AC direct light emitting diode power supply (AC Direct LED), but the present disclosure is not limited thereto.

As shown in FIG. 1, a light emitting diode power supply 110 for general lighting is coupled to an external power supply 120. In some embodiments, the external power supply 120 may be AC mains electricity power.

In some embodiments, the light emitting device 100 includes a battery 130, and the battery 130 is coupled to a part of the light emitting diode units L1 to L10. For example, as illustrated in FIG. 1, the battery 130 is coupled to the light emitting diode unit L7 and the light emitting diode unit L9.

When the light emitting diode units L1 to L10 receive the power supplied from the external power supply 120, the external power supply 120 charges the battery 130 through a part of the light emitting diode units of the light emitting diode units L1 to L10 and drives the light emitting diode units L1 to L10 so that the light emitting diode units L1 to L10 are illuminated. For example, as illustrated in FIG. 1, when the light emitting diode units L1 to L10 receive the power supplied from the external power supply 120, the external power supply 120 passes through the light emitting diode unit L1 to L6 of the light emitting diode units L1 to L10, to charge the battery 130.

And when the light emitting diode units L1 to L10 do not receive the power supplied from the external power supply 120, the battery 130 discharges to drive at least one of the plurality of light emitting diode units L1 to L10. For example, as illustrated in FIG. 1, when the light emitting diode units L1 to L10 do not receive the power supplied from the external power supply 120, the battery 130 discharges to drive the light emitting diode units L9 to L10 as emergency lighting.

In some embodiments, the light emitting device 100 further includes a discharging switch 160. In some embodiments, when the light emitting diode units L1 to L10 do not receive the power supplied from the external power supply 120, the discharging switch 160 is turned on to discharge the battery 130, and when the light emitting diode units L1 to L10 receive the power supplied from the external power supply 120, the discharging switch 160 is turned off to stop the battery 130 from discharging.

In some embodiments, the light emitting device 100 also includes an emergency lighting switch 180. In some embodiments, when the discharging switch 160 is turned on, the emergency lighting switch 180 is turned on so that the battery 130 drives at least one of the light emitting diode units L1 to L10. When the discharging switch 160 is turned off, the emergency lighting switch 180 is turned off so that the battery 130 stops driving at least one of the light emitting diode units L1 to L10. For example, as shown in FIG. 1, when the discharging switch 160 is turned on, the emergency lighting switch 180 is turned on, and the battery 130 drives the light emitting diode units L9 to L10. When the discharging switch 160 is turned off, the emergency lighting switch 180 is turned off, and the battery 130 stops driving the light emitting diode units L9 to L10.

In some embodiments, the light emitting device 100 further includes a control circuit 150. When the light emitting diode units L1 to L10 do not receive the power supplied from the external power supply 120, the control circuit 150 turns on the discharging switch 160, and when the light emitting diode units L1 to L10 receive the power supplied from the external power supply 120, the control circuit 150 turns off the discharging switch 160.

In some embodiments, the light emitting device 100 also includes an external power supply detecting element 140. In some embodiments, The external power supply detecting element 140 detects whether or not the plurality of light emitting diode units L1 to L10 receive the power supplied from the external power supply 120 and transmits the detection result to the control circuit 150.

In some embodiments, the light emitting device 100 further comprises a constant current circuit 170. The constant current circuit 170 is coupled to the battery 130 to control the current input to the battery 130 from the external power supply 120. In some embodiments, the constant current circuit 170 may control the magnitude of the current input to the battery 130, the magnitude of the voltage, and/or the direction of the current.

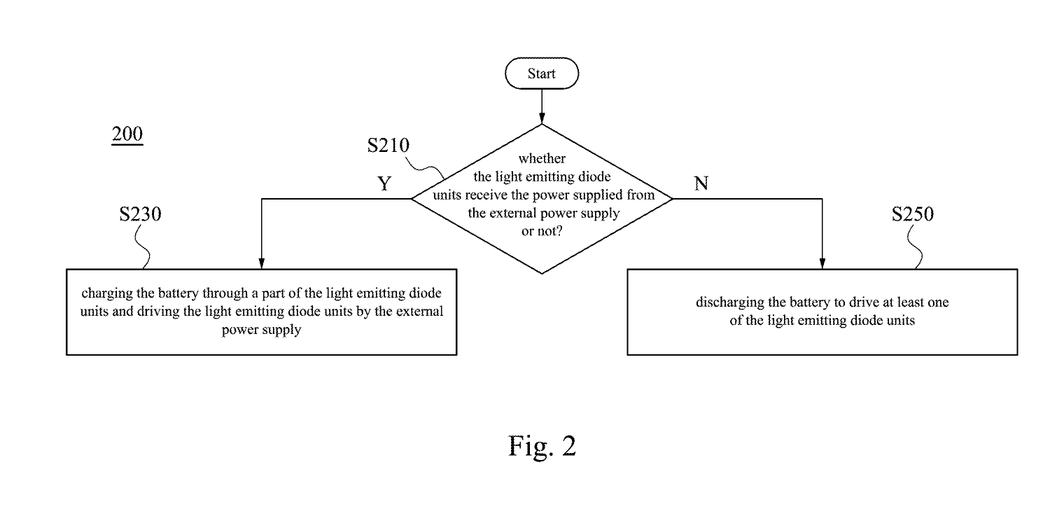

Reference is made to FIG. 2. FIG. 2 is a flow diagram illustrating a driving method 200 of a light emitting device according to some embodiments of the present disclosure. The driving method 200 of the light emitting device includes the following operations:

Operation S210: detecting whether the light emitting diode units receive the power supplied from the external power supply or not;

Operation S230: charging the battery through a part of the light emitting diode units and driving the light emitting diode units by the external power supply; and

Operation S250: discharging the battery to drive at least one of the light emitting diode units.

For ease of understanding the driving method 200 of the light emitting device of the embodiment of the present disclosure, reference is made to FIG. 1 and FIG. 2.

In operation S210, detecting whether the light emitting diode units receive the power supplied from the external power supply or not. For example, detecting whether the light emitting diode units L1 to L10 receive the power supplied from the external power supply 120 or not by the external power supply detecting element 140 of FIG. 1. If result of operation S210 is that the light emitting diode units receive the power supplied from the external power supply 120, operation S230 is performed. If the result of operation S210 is that the light emitting diode units do not receive the power supplied from the external power supply 120, operation S250 is performed.

In operation S230, charging the battery through a part of the light emitting diode units and driving the light emitting diode units by the external power supply. For example, reference is made to FIG. 1, when the detection result of the external power supply detecting element 140 is that the light emitting diode units L1 to L10 receive the power supplied from the external power supply 120, the external power supply 120 charges the battery 130 through the light emitting diode units L1 to L6 and drives the light emitting diode units L1 to L10 so that the light emitting diode units L1 to L10 are illuminated.

In operation S250, discharging the battery to drive at least one of the light emitting diode units. For example, reference is made to FIG. 1, when the detection result of the external power supply detecting element 140 is that the light emitting diode units L1 to L10 do not receive the power supplied from the external power supply 120, the battery 130 discharges to drive the light emitting diode units L9 to L10.

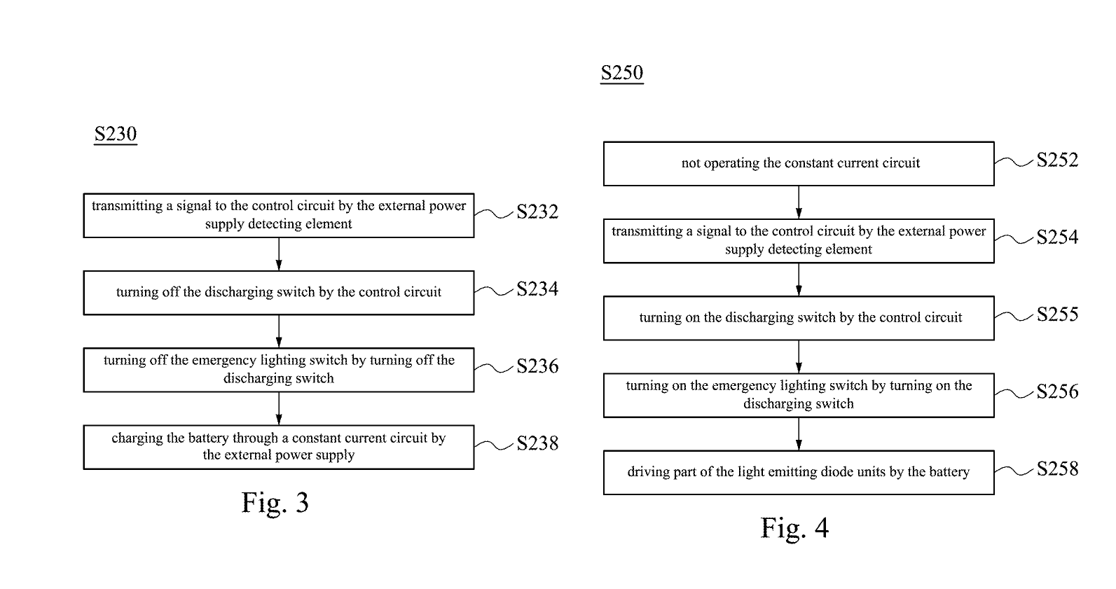

Reference is made to FIG. 3. FIG. 3 is a flow chart illustrating operation S230 in the method of FIG. 2 according to some embodiments of the present disclosure. Operation S230 includes the following operations:

Operation S232: transmitting a signal to the control circuit by the external power supply detecting element;

Operation S234: turning off the discharging switch by the control circuit;

Operation S236: turning off the emergency lighting switch by turning off the discharging switch; and

Operation S238: charging the battery through a constant current circuit by the external power supply.

In operation S232, transmitting a signal to the control circuit by the external power supply detecting element. For example, reference is made to FIG. 1, when the detection result of the external power supply detecting element 140 is that the light emitting diode units L1 to L10 receive the electric power supplied from the external power supply 120, the external power supply detecting element 140 transmits the detection result to the control circuit 150.

In operation S234, turning off the discharging switch by the control circuit. For example, reference is made to FIG. 1. The control circuit 150 may control to turn off the discharging switch 160.

In operation S236, turning off the emergency lighting switch by turning off the discharging switch. For example, reference is made to FIG. 1. When the discharging switch 160 is turned off, the discharging switch 160 turns off the emergency lighting switch 180, causing the battery 130 to stop driving the light emitting diode units L9 to L10.

In operation S238, charging the battery through a constant current circuit by the external power supply. For example, reference is made to FIG. 1. The external power supply 120 may charge the battery 130 through the light emitting diode units L1 to L6 and a constant current circuit 170.

Reference is made to FIG. 4. FIG. 4 is a flow chart illustrating operation S250 in FIG. 2 according to some embodiments of the present disclosure. Operation S250 includes the following operations:

Operation S252: not operating the constant current circuit;

Operation S254: transmitting a signal to the control circuit by the external power supply detecting element;

Operation S255: turning on the discharging switch by the control circuit;

Operation S256: turning on the emergency lighting switch by turning on the discharging switch; and

Operation S258: driving part of the light emitting diode units by the battery.

In operation S252, not operating the constant current circuit. For example, reference is made to FIG. 1. When the external power supply 120 does not supply power to the light emitting diode units L1 to L10, the constant current circuit 170 does not operate and the battery 130 is not charged.

In operation S254, transmitting a signal to the control circuit by the external power supply detecting element. For example, reference is made to FIG. 1. When the detection result of the external power supply detecting element 140 is the light emitting diode units L1 to L10 do not receive the power supplied from the external power supply 120, the external power supply detecting element 140 transmits the detection result to the control circuit 150.

In operation S255, turning on the discharging switch by the control circuit. For example, reference is made to FIG. 1. The control circuit 150 may control to turn on the discharging switch 160.

In operation S256, turning on the emergency lighting switch by turning on the discharging switch. For example, reference is made to FIG. 1. When the discharging switch 160 is turned on, the discharging switch 160 turns on the emergency lighting switch 180.

In operation S258, driving part of the light emitting diode units by the battery. For example, reference is made to FIG. 1. When the discharging switch 160 is turned on and the emergency lighting switch 180 is turned on, the battery 130 drives the light emitting diode units L9 to L10.

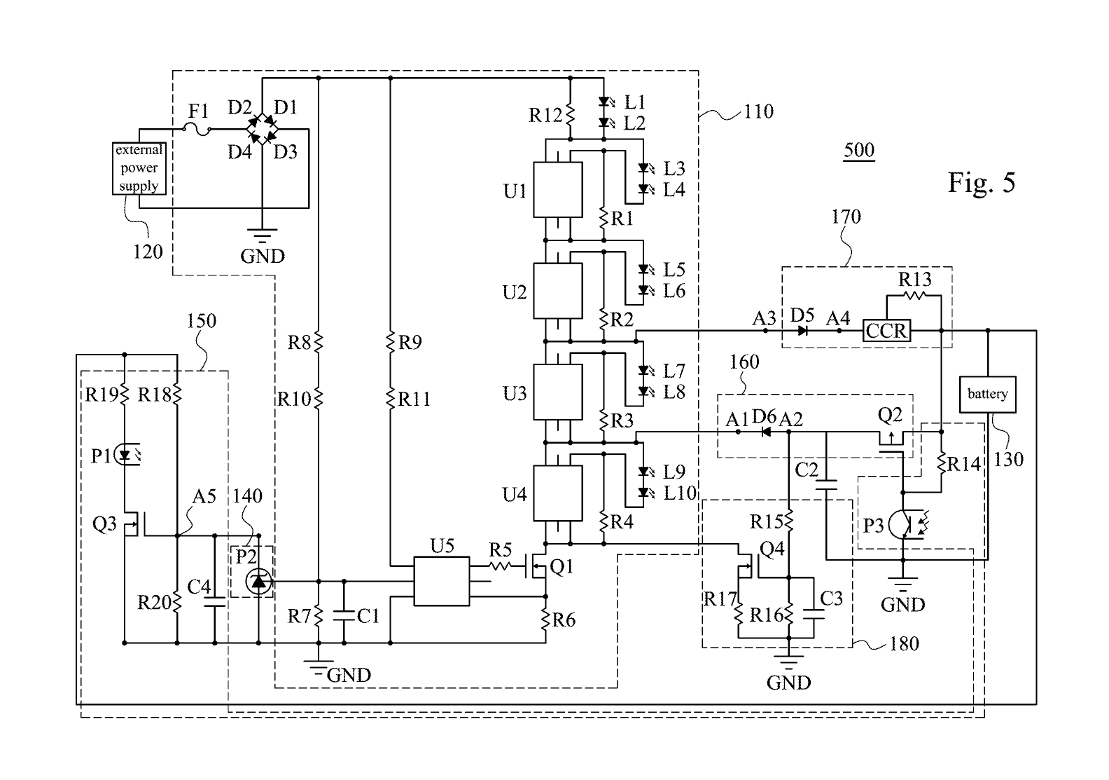

Reference is made to FIG. 5. FIG. 5 is a schematic diagram illustrating a light emitting device 500 according to some embodiments of the present disclosure. The light emitting diode power supply 110, the external power supply 120, and the battery 130 for general lighting shown in FIG. 5 are the same as those in FIG. 1, and will not be described again.

As shown in FIG. 5. The light emitting device 500 further includes resistors R13 to R20, capacitors C2 to C4, diodes D5 to D6, optocouplers P1 and P3, TL431 element P2, transistors Q2 to Q4, and constant current regulator CCR. In some embodiments, the TL431 element P2 is an external power supply detecting element 140. In some embodiments, the diode D6 and the transistor Q2 constitute the discharging switch 160 together. The resistors R14, R18 to R20, the transistor Q3, the capacitor C4, and the photocouplers P1 and P3 constitute the control circuit 150 together. The resistors R15 to R17 and the capacitor C3 and the transistor Q4 constitute the emergency lighting switch 180 together. The diode D5, the resistor R13 and the constant current regulator CCR constitute the constant current circuit 170 together.

When the external power supply 120 supplies power to the light emitting diode units L1 to L10, the TL431 element P2 is turned on. Since the TL431 element P2 is turned on, the transistor Q3 is not conducted. Since the transistor Q3 is not conducted, no current passes through the photocoupler P1. Since no current passes through the photocoupler P1, the optocoupler P3 is not conducted. Since the optocoupler P3 is not conducted, the transistor Q2 is not conducted. Since the transistor Q2 is not conducted, the transistor Q4 is not conducted. Since the voltage at the terminal A1 of the diode D6 is higher than the voltage at the terminal A2 of the diode D6, the diode D6 is not conducted. Since the voltage at the terminal A3 of the diode D5 is greater than the voltage at the terminal A4 of the diode D5, the diode D5 is turned on. After the diode D5 is turned on, the external power supply 120 charges the battery 130 via the light emitting diode units L1 to L6 and the constant current circuit 170 composed of the diode D5 and the resistor R13 and the constant current regulator CCR.

When the external power supply 120 does not supply power to the light emitting diode units L1 to L10, the TL431 element P2 is not conducted. Since the voltage at the terminal A3 of the diode D5 is smaller than the voltage at the terminal A4 of the diode D5, the diode D5 is not turned on. Since the diode D5 is not conducted, the TL431 element P2 is not conducted, the battery 130 supplies a voltage to the terminal A5, and the transistor Q3 is turned on. Since the transistor Q3 is turned on, the photocoupler P1 has a current flowing through. Since the photocoupler P1 is turned on, the photocoupler P3 is turned on. Since the photocoupler P3 is turned on, the transistor Q2 is turned on. Since the transistor Q2 is turned on, the transistor Q4 is turned on. Since the voltage at the terminal A1 of the diode D6 is lower than the voltage at the terminal A2 of the diode D6, the diode D6 is turned on. After the diode D6 is turned on, the battery 130 discharges to the light emitting diode units L9 to L10 to turn on the light emitting diode units L9 to L10.

In some embodiments, the light emitting diode power supply 110 for general lighting may be a device or circuit having a function for driving light emitting diode units L1 to L10 or other equivalent function. In some embodiments, the battery 130 may be a battery or other equivalent device or circuit having a charging and discharging function.

The light emitting device 100 and the light emitting device 500 described above are merely for illustrative purposes and the present disclosure is not limited thereto.

According to the embodiment of the present disclosure, it is understood that the embodiment of the present disclosure is to provide a light emitting device and a driving method thereof, whereby the light emitting diode units for conventional general lighting is used as the light emitting diode units for emergency lighting in an emergency situation, effectively reducing the volume of the light emitting device. In addition, the embodiment of the present disclosure uses the circuit path of light emitting diode units of the conventional general lighting to charge the battery, no additional switching power supply is needed, effectively reducing the complexity of the circuits of the light emitting device.

In this document, the term “coupled” may also be termed as “electrically coupled”, and the term “connected” may be termed as “electrically connected”. “Coupled” and “connected” may also be used to indicate that two or more elements cooperate or interact with each other. As used herein, the term “and/or” includes any and all combinations of one or more of the associated listed items.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A light emitting device, comprising:
a plurality of light emitting diode units connected in series with each other; and
a battery coupled to a part of the light emitting diode units;
wherein when the light emitting diode units receive power supplied from an external power supply, the external power supply charges the battery through the part of the light emitting diode units, and drives the light emitting diode units, and when the light emitting diode units do not receive power supplied from the external power supply, the battery discharges to drive at least one of the light emitting diode units.

2. The light emitting device of claim 1, further comprising:
a discharging switch configured to be turned on to discharge the battery when the light emitting diode units do not receive power supplied from the external power supply, and configured to be turned off to stop discharging the battery when the light emitting diode units receive power supplied from the external power supply.

3. The light emitting device of claim 2, further comprising:
an emergency lighting switch, wherein the emergency lighting switch is turned on when the discharging switch is turned on so that the battery drives the at least one of the light emitting diode units, and the emergency lighting switch is turned off when the discharging switch is turned off so that the battery stops driving the at least one of the light emitting diode units.

4. The light emitting device of claim 2, further comprising:
a control circuit configured to turn on the discharging switch when the light emitting diode units do not receive power supplied from the external power supply, and configured to turn off the discharging switch when the light emitting diode units receive power supplied from the external power supply.

5. The light emitting device of claim 4, further comprising:
an external power supply detecting element configured to detect whether the light emitting diode units receive power supplied from the external power supply or not and configured to transmit a detection result to the control circuit.

6. The light emitting device of claim 1, further comprising:
a constant current circuit coupled to the battery, wherein the constant current circuit is configured to control a current input to the battery from the external power supply.

7. A driving method of a light emitting device, wherein the light emitting device comprises a plurality of light emitting diode units connected in series with each other and a battery, and the battery is coupled to a part of the light emitting diode units, wherein the driving method comprises:
detecting whether the light emitting diode units receive power supplied from an external power supply or not; and
charging the battery through the part of the light emitting diode units by the external power supply when the light emitting diode units receive power supplied from the external power supply and driving the light emitting diode units, and discharging the battery to drive at least one of the light emitting diode units when the light emitting diode units do not receive power supplied from the external power supply.

8. The driving method of claim 7, further comprising:
turning on a discharging switch to discharge the battery when the light emitting diode units do not receive power supplied from the external power supply, and turning off the discharging switch to stop discharging the battery when the light emitting diode units receive power supplied by the external power supply.

9. The driving method of claim 8, further comprising:
turning on an emergency lighting switch when the discharging switch is turned on so that the battery drives the at least one of the light emitting diode units, and turning off the emergency lighting switch when the discharging switch is turned off so that the battery stops driving the at least one of the light emitting diode units.

10. The driving method of claim 8, further comprising:
transmitting a detection result of detecting whether the light emitting diode units receive power supplied from the external power supply or not to a control circuit.
